(19) United States
(12) Patent Application Publication
(10) Pub. No.: US 2012/0240118 A1
(43) Pub. Date: Sep. 20, 2012

(54) TERMINAL AND COMPUTER FOR OPERATION WITH AN ASSEMBLY FOR VIRTUAL DATA PROCESSING, ASSEMBLY AND METHOD FOR VIRTUAL DATA PROCESSING

(75) Inventors: Diana Filimon, Gersthofen (DE); Johannes Linne, Todtenweis (DE); Maximilian Pfänder, Bobingen (DE); Nils Wittler, Fischach (DE)

(73) Assignee: Fujitsu Technology Solutions Intellectual Property GmbH, München (DE)

(21) Appl. No.: 13/505,006

(22) PCT Filed: Oct. 21, 2010
(86) PCT No.: PCT/EP2010/065894

§ 371 Date: Jun. 1, 2012

(30) Foreign Application Priority Data
Nov. 6, 2009 (DE) 10 2009 052 156.9

(51) Int. Cl. G06F 9/455; G06F 15/16

(52) U.S. Cl. 718/1

(57) ABSTRACT

A terminal for operation with an assembly for virtual data processing includes a controller, an adaptation unit coupled to the controller, a virtualization interface linked to the controller which accesses data processing resources, a display coupled to the virtualization interface via the adaptation unit which displays information, a communication unit coupled to the controller and to the virtualization interface, and an energy supply coupled to the controller which provides energy to operate the terminal, wherein the controller, the energy supply, the adaptation unit, the virtualization interface and the communication unit are integrated in a housing of the display.

### RELATED APPLICATIONS

This is a §371 of International Application No. PCT/EP2010/065894, with an inter-national filing date of Oct. 21, 2010 (WO 2011/054680, published May 12, 2011), which is based on German Patent Application No. 10 2009 052 156.9, filed Nov. 6, 2009, the subject matter of which is incorporated by reference.

### TECHNICAL FIELD

This disclosure relates to a terminal and a computer for operation with an assembly for virtual data processing, to the assembly for virtual data processing and to a method for virtual data processing.

### BACKGROUND

In information technology (IT), virtualization concepts are often used, in particular, in companies to ensure the high availability of applications. In virtualization, the architecture of an IT infrastructure is based on a central system which centrally combines physical resources, for example, memory, computing power, operating system or applications and provides users with those resources. Physical resources are abstracted with the aid of virtualization. From the point of view of a user, these resources are feigned since they are actually not present at the workstation. However, they can be used like actual components. The data are thus processed virtually using remote access to a server.

Virtualization concepts differ on the basis of the physical layer on which they are based. This layer may be, for example, the hardware of a central computer called a server, the operating system or the memory subsystem. In terms of the user, a distinction is accordingly made between so-called “fat” clients and “thin” clients, depending on how much computing power a computer at the user's workstation locally provides and how much computing power is used by the server. The common aims of all virtualization concepts are better use of resources, simpler management and operation and an associated cost saving.

The virtualization on which this application is based is so-called “desktop” virtualization. In this case, the entire software, that is to say the operating system, applications and also the workstation of a user which is simulated using software, the so-called “desktop,” runs on a remote server. The devices present at the workstation are, therefore, used by a user primarily to input and output data.

In currently available solutions for desktop virtualization, a plurality of separate devices, for example, an output device, that is to say a display, and a connection unit to the server with its own respective power supply, are used on the user side and connected by cables. This makes installation and maintenance difficult, complicates operation and increases the susceptibility to faults.

It could therefore be helpful to improve and simplify virtual data processing, in particular, in the field of desktop virtualization.

### SUMMARY

We provide a terminal for operation with an assembly for virtual data processing including a controller, an adaption unit coupled to the controller, a virtualization interface linked to the controller which accesses data processing resources, a display coupled to the virtualization interface via the adaptation unit which displays information, a communication unit coupled to the controller and to the virtualization interface, and an energy supply coupled to the controller which provides energy to operate the terminal, wherein the controller, the energy supply, the adaptation unit, the virtualization interface and the communication unit are integrated in a housing of the display.

We also provide a computer for operation with an assembly for virtual data processing including a processor, a memory coupled to the processor, an interface coupled to the processor which interchanges data, a virtualization layer which can be executed on the processor, at least one entity of a personal computer, which entity can be executed on the virtualization layer and has a service unit to provide data processing resources for a virtualization interface of a terminal, and a protocol conversion unit coupled to the interface to interchange data.

We further provide an assembly for virtual data processing including the computer for virtual data processing, at least one terminal, and a communication network which interchanges data between the computer and the at least one terminal.

We still further provide a method for virtual data processing with the assembly, including switching on the terminal, setting up a connection from the terminal to the computer, displaying state information on the terminal, using the terminal for data processing, and switching off the terminal.

### BRIEF DESCRIPTION OF THE DRAWINGS

FIG. 1 schematically shows an example of our terminal.

FIG. 2 schematically shows an example of our computer.

### LIST OF REFERENCE SYMBOLS

1 Controller
2 Virtualization interface
3 Display
4 Adaptation unit
5 Split device
6 Energy supply
7, 7a Connection
8 Interface for wireless data transmission
9 Drive element
10 User interface
11 Multifunction button
12 Drive unit
13 Display element
14 Drive means
15 Peripheral interface
20 Processor
21 Memory
22 Interface
23 Virtualization layer
24 Entity of a personal computer
25 Service unit
26 Protocol conversion unit

### DETAILED DESCRIPTION

We provide a terminal for operation with an assembly for virtual data processing which may comprise a controller, a virtualization interface, a display, an adaptation unit, a communication unit and an energy supply. The controller is coupled to the virtualization interface, the adaptation unit, the communication unit and the energy supply. The virtualization interface is suitable for accessing data processing resources. The display is coupled to the virtualization interface via the adaptation unit and is designed to display information. The communication unit is additionally coupled to the virtualization interface. The energy supply is set up to provide energy for operating the terminal. The controller, the energy supply, the adaptation unit, the virtualization interface and the communication unit are integrated in a housing of the display.

When the terminal is switched on, the controller, the virtualization interface, the adaptation unit, the display, the communication unit and the energy supply are switched on. The communication unit establishes a connection to the assembly for virtual data processing. An incoming data stream is displayed on the display using the virtualization interface and the adaptation unit. In this case, the adaptation unit converts the video signals provided by the assembly into a video signal format which can be used by the display. The user uses the hardware and software resources provided by the assembly in the form of a virtual desktop.

As a result of the fact that all components of the terminal are integrated in a housing, operation is simplified and the susceptibility to faults is reduced on account of the reduced cables. Furthermore, this minimizes the terminal. Installation, maintenance and replacement of terminals are simplified.

The display comprises, in particular, a liquid crystal display, a so-called “LC” display. The adaptation unit is also referred to as a scaler. The energy supply is also referred to as a power supply.

The communication unit may have a split device coupled to the energy supply and comprises a connection for supplying energy and for interchanging data.

The split device separates energy supplied by the assembly for virtual data processing from supplied data. The energy obtained in this manner is supplied to the energy supply. The data are forwarded to the virtualization interface.

The terminal thus advantageously requires only one connection cable, namely the cable for the split device, to connect the terminal to the assembly for virtual data processing. This simplifies and speeds up installation of the terminal. The mean time between failure, MTBF, is consequently increased.

One possible implementation is based on the use of Power over Ethernet, for example, according to the IEEE standard 802.3 af, in which both power supply and data interchange are effected via the network cable. The split device is then referred to as a splitter. A further possible implementation is the use of powerline LAN. In this case, both power supply and network use are effected via the mains cable carrying 220 V.

Alternatively, the communication unit has an interface for wireless data transmission. Furthermore, a connection coupled to the energy supply is provided for the purpose of supplying energy.

The data provided by the assembly are supplied to the virtualization interface via the interface for wireless data transmission. Energy is supplied via a 220 V connection to the power supply system.

In this case too, the terminal is connected to the infrastructure, that is to say the assembly for virtual data processing, only via one connection cable, namely the power cable.

The interface for wireless data transmission comprises, in particular, a wireless LAN, WLAN, interface, for example, according to one of the IEEE standards 802.11x. The interface is in the form of an access point.

The controller may have a drive element for the energy supply, which drive element is set up to regulate a power supply for the terminal on the basis of a respective operating state of the terminal.

All of the components of the terminal, in particular, the controller, the virtualization interface, the display, the adaptation unit and the communication unit, are supplied with power with the aid of the drive element and the energy supply using only one power supply unit. The drive element carries out, in conjunction with the energy supply, integrated power management of all components of the terminal. In this case, the logical links between the components are used, in particular, during switch-on and switch-off and when assuming energy-saving states. The power supply is controlled with respect to a respective operating state of a respective component. The drive element thus regulates a respective power supply for all components, controls the energy status of the infrastructure coupled to the terminal via the assembly and provides status information relating to the energy state of the individual components of the terminal.

The terminal may have a user interface coupled to the controller and is intended for interaction with a user.

The user interface may comprise a multifunction button designed at least to switch the terminal on and off. The controller comprises a unit coupled to the multifunction button and intended to drive the multifunction button.

Operation of the multifunction button triggers switch-on of the terminal and the automatic set-up of a connection to the assembly for virtual data processing. In this case, connection set-up comprises the initiation of log-on of the user. Renewed operation of the multifunction button results in the connection to the assembly being cleared, in the user logging off and in the terminal being switched off.

Operation of the device is simplified on account of the multifunction button since the entire functionality of the terminal can be used with the push of a button. It is possible to immediately work without a waiting time.

In one development, the multifunction button comprises at least one sensor, at the output of which a sensor signal is provided. This signal is supplied to the unit to drive the multifunction button.

The at least one sensor of the multifunction button, together with the drive means unit, enables identification of the user.

This advantageously results in the logging-on operation when setting up the connection to the assembly also being automated when the terminal is switched on. Consequently, it is possible, for example, to start up the components of the terminal in a parallel manner with the operation of logging onto the infrastructure.

The sensor is realized in the form of a fingerprint sensor, for example. To further improve the authentication of the user, further sensors may be provided, for example, a heat sensor, a motion sensor, a skin resistance sensor, a camera or an RFID sensor.

The user interface may comprise a display element to display at least two operating states of the terminal. The controller has a unit that drives the display element. A state signal is provided at the output of the unit, which signal is supplied to the display element.

Different operating states of the terminal are displayed on the display element as a function of the state signal.

Essential states of the terminal are thus advantageously clearly displayed to a user, which considerably simplifies operation of the terminal.

In this case, the display element is implemented, for example, on the basis of light-emitting diodes, LEDs.

The state signal may be generated on the basis of superimposition of provided operating states of the terminal.

The states assumed by the components of the terminal are summarized in superordinate operating states of the terminal and displayed using the unit for driving the display element.

The terminal may have a peripheral interface coupled to the virtualization interface and comprising at least one connection to an external device.

At least one external device can be connected to the terminal via the peripheral interface. The external device is, for example, in the form of a keyboard, a mouse or a local memory. The peripheral interface is in the form of a USB or PS2 interface, in particular.

A computer for virtual data processing may comprise a processor, a memory coupled to the processor, an interface coupled to the processor and is intended to interchange data, a virtualization layer which can be executed on the processor, and at least one entity of a personal computer, which entity can be executed on the virtualization layer. The at least one entity of a personal computer has a service unit for providing data processing resources for a virtualization interface of a terminal. A protocol conversion unit coupled to the interface for interchanging data is additionally provided in the computer.

The virtualization layer forms an abstraction layer of the hardware of the computer, that is to say at least of the memory, the processor and the interface for interchanging data. The virtualization layer is thus the basis for the at least one entity of a personal computer, PC. The entity of the personal computer thus has at least the hardware of the computer, which is simulated as a virtual machine, as well as an operating system together with applications and the desktop of the associated user. The at least one entity of a personal computer provides the virtualization interface of the terminal with the data processing resources with the aid of the service unit. Data are interchanged between the virtualization interface of the terminal and the service unit of the computer via a protocol. The protocol conversion unit translates a protocol of the terminal into a protocol of the computer and vice versa.

From the point of view of the terminal, the protocol conversion unit advantageously ensures transparency of the protocol used to interchange data with the computer. This contributes to significant simplification of the implementation of the terminal.

Currently used protocols comprise, for example, the remote desktop protocol, (RDP, or the ICA protocol.

The service unit is also referred to as a connection broker.

The protocol conversion unit may be implemented inside the at least one entity of the personal computer.

In this case, the protocol conversion unit is implemented using software.

In one development, the protocol conversion unit is realized in the form of additional hardware.

In this case, the protocol conversion unit is implemented, for example, as an additional plug-in card for the computer.

The two above-mentioned implementations of the protocol conversion unit can also be combined by implementing part of the functionality of the protocol conversion unit using hardware and by implementing another part as software.

An assembly for virtual data processing may have a computer, at least one terminal, and a communication network which is suitable for interchanging data between the computer and the at least one terminal.

The at least one terminal and the computer are connected via the communication network. The computer provides data processing resources for the terminal. The terminal makes it possible to display information to a user and enables the user to interact with the computer, in particular.

The assembly is used to feign the remote computer, together with the software, to the user as a locally usable resource. The virtual data processing is controlled and simplified using the integrated terminal in conjunction with the protocol transparency implemented in the computer.

The communication network is in the form of an Ethernet, a powerline LAN or a WLAN, for example.

A method for virtual data processing with an assembly described above may have the following steps:

switching on the terminal,

setting up a connection from the terminal to the computer, displaying state information on the terminal, using the terminal for data processing, and switching off the terminal.

In this case, the operation of switching on the terminal comprises an operation of switching on all components of the terminal, in particular the display, the controller, the virtualization interface, the adaptation unit, the energy supply and the communication unit, in a suitable order. As soon as a connection to the computer has been started, the terminal can be used for data processing. In the entire time between switching on the terminal and switching off the terminal, state information is displayed on the display unit of the terminal. The operation of switching off the terminal comprises, in particular, an operation of switching off all components of the terminal described above in a suitable order.

The operation of switching on the terminal may comprise identification of a user.

This advantageously makes it possible to operate the terminal in a particularly simple and reliable manner with few faults.

Our computers, terminals, assemblies and methods will be explained in more detail below using examples with reference to the figures. Functional elements having the same function or effect have the same reference symbols. Insofar as elements correspond in terms of their function, the description of the elements is not repeated in each of the subsequent figures.

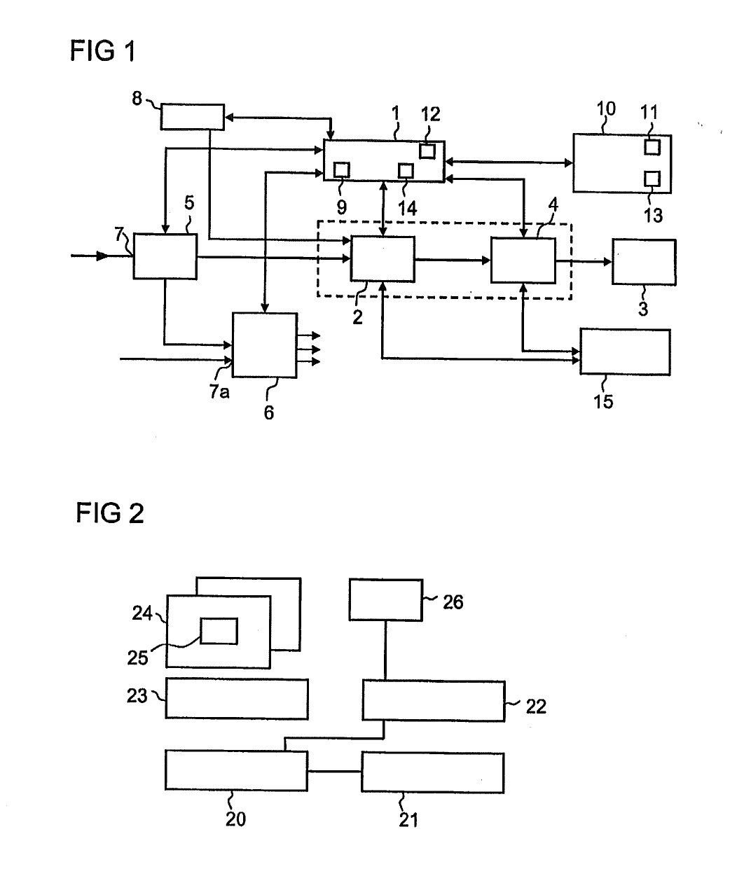

FIG. 1 shows an example of a terminal for operation with an assembly for virtual data processing according to our principle. The terminal comprises a controller 1, a virtualization interface 2, a display 3, an adaptation unit 4, a split device 5, an energy supply 6, a user interface 10 and a peripheral interface 15. The controller 1 is coupled to the virtualization interface 2, the adaptation unit 4, the split device 5, the energy supply 6 and the user interface 10. The split device 5 has a connection 7 for receiving energy and for interchanging data. The energy supply 6 is coupled to the split device 5 and provides energy for the above-mentioned components of the terminal, as indicated by the three arrows to the right of the energy supply 6 in FIG. 1. The controller 1, the virtualization interface 2, the adaptation unit 4, the split device 5, the energy supply 6, the user interface 10 and the peripheral interface 15 are integrated in a housing of the display 3.

The controller 1 comprises a drive element 9 for the energy supply 6. The element 9 is designed to regulate a power supply for the terminal. Joint power management is thus effected for all components of the terminal.

The user interface 10 has a multifunction button 11 and a display element 13. The controller 1 has a unit 12 coupled to the multifunction button 11 and intended to drive the multifunction button 11, as well as a unit 14 for driving the display element 13.

The display 3 is in the form of an LC display. The adaptation unit 4 is also referred to as a scaler.

The peripheral interface 15 comprises at least one connection for an external device, for example, a keyboard, a mouse or a USB terminal.

The terminal is switched on by operating the multifunction button 11. Energy and data, for example, from a local area network (LAN) or via a power supply system, are supplied to the terminal via the connection 7 of the split device 5. The split device 5 separates the energy from the data stream. The energy is supplied to the energy supply 6 and the data stream is supplied to the virtualization interface 2. The controller 1 uses the supplied energy to switch on the individual components of the terminal in a suitable order. The virtualization interface 2 makes it possible to access data processing resources and provides the adaptation unit 4 with a video signal. This video signal is in the VGA or DVI format, for example. The adaptation unit 4 converts this format into a format for the display 3, for example, into LVDS. The video signals are displayed on the display 3. A current operating state of the terminal, which results from the superimposition of the operating states of the individual components, is respectively additionally displayed on the display element 13.

The terminal advantageously uses resources provided by an assembly for virtual data processing. In this case, the resources may be centrally bundled and used in a controlled manner. Inhomogeneous resources are also transparent to a user. The terminal advantageously has precisely the one connection 7 with which it is connected to the assembly. This considerably simplifies maintenance and installation.

The connection 7 may be connected to a communication network with Power over Ethernet capability. The connection 7 is coupled to a powerline LAN communication network.

The multifunction button 11 additionally may have a fingerprint sensor and a heat sensor. Fingerprint comparison information is stored, for example, in a memory of the terminal. The data relating to only a few users are stored here with high resolution, for example. This is particularly advantageous in office environments or in the home because only a few users work on a terminal there. Alternatively, the comparison information for the fingerprint sensor may be stored in the assembly for virtual data processing.

When the multifunction button 11 has a fingerprint sensor, the following exemplary sequence results when switching on the terminal: placing a finger on the button triggers switching-on of the energy supply 6. A connection set-up message containing the identification number of the terminal is transmitted to the assembly. The entity of a virtual PC, which corresponds to the most likely user, is prepared and activated on the computer in the assembly using the identification number. The most likely user is either a defined standard user or the most frequent user determined from a list. The fingerprint is compared with the comparison information in the terminal or with the aid of the computer. The actual user is determined. Log-on of this user with the associated password is then initiated. The entity of a virtual PC which has already been prepared is activated and released.

This parallelism considerably shortens the switch-on time of the terminal.

The terminal is switched off in two stages, for example: a log-off sequence is initiated by briefly pressing the multifunction button 11. The user is logged off from the computer via the virtualization interface 2 and resources in the computer are released. The entity of the personal computer is paused on the computer, for example. A switch-off sequence is initiated by pressing the multifunction button 11 for a long time. Resources are released on the server. For example, the entity of the PC is stopped. Individual components in the terminal are then changed to a switched-off state, a low-energy state or a sleep state, depending on the implementation of the drive element 9 for the energy supply 6.

Alternatively, the terminal comprises an interface 8 for wireless data transmission and a connection 7a for supplying energy. The interface 8 for wireless data transmission is coupled, on the one hand, to the controller 1 and, on the other hand, to the virtualization interface 2. The connection 7a is coupled to the energy supply 6. The interface 8 for wireless data transmission is in the form of a wireless LAN interface, for example. In this case, the connection 7a is connected to the power supply system, that is to say to an AC voltage of 220 V. The terminal may also be connected to the infrastructure via precisely one connection, namely the connection 7a.

The display element 13 may comprise a two-color light-emitting diode (LED), for example. The operating states of the terminal are then displayed in coded form as follows, for example: in the switched-off state of the terminal, the LED is off; if the terminal is switched on and is setting up a connection to the assembly, the LED flashes green; if the terminal is switched on and is connected to the assembly, the LED is permanently green; if a fault occurs, the LED is red. The available states of the individual components are mapped to the above-described states of the terminal with the aid of the drive means unit 14.

In this case, the drive means unit 14 generates two groups of signals, for example: group 1 comprises an overall status signal which is formed from the superimposition of individual state signals of the components; group 2 comprises extended status information.

For group 2, eight signals are evaluated as one byte, for example. The extended status display of group 2 can then be additionally controlled with the multifunction button 11. The extended status information can also be output as a pulse sequence, as a serial color code or as a byte code with the aid of four light-emitting diodes.

The states which can be assumed by the virtualization interface 2, the display 3 and the split device 5, for example, are used as the basis for the superimposition. States which can be assumed by the split device 5 are: switched on, network active, connected. The virtualization interface 2 may assume the states: switched on, connection to the server active, connection to the server terminated. States of the display 3 are: switched on, energy-saving state, standby state, fault and switched off.

Starting out from this, the state “terminal switched on and connected to the assembly” is assumed when the split device 5 is in the state “connected” and the virtualization interface 2 is in the state “connection to the server active” and the display 3 is either in the state “switched on” or in the energy-saving state.

The switched-off state of the terminal results when the split device 5 or the virtualization interface 2 is not in the switched-on state.

The occurrence of a fault is indicated when the split device 5 is not in the state “connected” and the terminal is not in the switched-off state.

A simple and comprehensible state display is advantageously implemented for a user by displaying the superimposed states. The variety of different state information relating to the individual components is filtered and only the essential states are clearly and distinctly displayed. Complete state information is additionally optionally displayed. In this case, the number of state information items which can be displayed can be configured for a respective user group.

The above-described components of the terminal correspond to logical functional units and are not mapped to physical components on a 1:1 basis. In particular, functional units may also be integrated in one physical component, for example, the virtualization interface 2 with the adaptation unit 4.

One possible structure of the terminal for operation with an assembly for virtual data processing comprises a display which is in the form of an LC display and in which the controller 1, the virtualization interface 2, the adaptation unit 3, the split device 5, the energy supply 6, the drive element 9, the user interface 10, the multifunction button 11, the unit 12 for driving the button, the display element 13, the drive means unit 14 for the latter and the peripheral interface 15 are integrated. The energy supply 6 and the split device 5 are designed for the use of Power over Ethernet. The peripheral interface 15 is a wireless USB interface, for example, with the result that the keyboard and mouse to operate the terminal are wirelessly connected. Consequently, the terminal connects to the connection 7 using precisely one cable.

FIG. 2 shows an example of a computer according to our principles. The computer comprises a processor 20, a memory 21 coupled to the latter, an interface 22 coupled to the processor 20 and intended to interchange data, a virtualization layer 23 which can be executed on the processor 20, and at least one entity 24 of a personal computer, which entity can be executed on the virtualization layer 23. The at least one entity 24 of the personal computer has a service unit 25 to provide data processing resources for the virtualization interface 2 of a terminal. The computer also has a protocol conversion unit 26 coupled to the interface 22 for interchanging data.

The interface 22 for interchanging data is in the form of an Ethernet interface according to the IEEE 802.x standard, for example. The virtualization layer 23 is also referred to as a “hyperviser.”

An executable entity 24 of a personal computer is generated on the virtualization layer 23 for each terminal according to FIG. 1 which is connected to the computer via a communication network. The entity 24 of a personal computer, in conjunction with the service unit 25 and the visualization interface 2 of the terminal, enables a user to access resources of the computer. These resources are, for example, computing power, operating system, memory, desktop. In this case, the protocol conversion unit 26 makes it possible to use any desired protocols between the service unit 25 of the computer and the visualization interface 2 of the terminal.

1. A terminal for operation with an assembly for virtual data processing comprising:
a controller,
an adaption unit coupled to the controller,
a virtualization interface which is linked to the controller and is suitable for which accesses data processing resources,
a display coupled to the virtualization interface via the adaptation unit which displays information,
a communication unit which is coupled to the controller and to the virtualization interface, and
an energy supply coupled to the controller which provides energy to operate the terminal,
wherein the controller, the energy supply, the adaptation unit, the virtualization interface and the communication unit are integrated in a housing of the display.

2. The terminal according to claim 1, wherein the communication unit has a split device coupled to the energy supply and comprises a connection to supply energy and interchange data.

3. The terminal according to claim 1, wherein the communication unit has an interface for wireless data transmission, and a connection coupled to the energy supply and receives energy.

4. The terminal according to claim 1, wherein the controller has a drive element for the energy supply, which drive element regulates a power supply for the terminal depending on a respective operating state of the terminal.

5. The terminal according to claim 1, further comprising a user interface coupled to the controller and which interacts with a user.

6. The terminal according to claim 5, wherein the user interface comprises a multifunction button which at least switches the terminal on and off, and the controller has a unit coupled to the multifunction button and drives the multifunction button.

7. The terminal according to claim 6, wherein the multifunction button comprises at least one sensor, at the output of which a sensor signal is provided, which signal is supplied to the unit to drive the multifunction button.

8. The terminal according to claim 5, wherein the user interface has a display element to display displaying at least two operating states of the terminal, and the controller comprises a unit that drives the display element, at the output of which unit a state signal is provided, which signal is supplied to the display element.

9. The terminal according to claim 8, wherein the state signal generated depends on superimposition of provided operating states of the terminal.

10. The terminal according to claim 1, further comprising a peripheral interface coupled to the virtualization interface and comprising at least one connection to an external device.

11. A computer for operation with an assembly for virtual data processing, comprising:
a processor,
a memory coupled to the processor,
an interface coupled to the processor which interchanges data,
a virtualization layer which can be executed on the processor,
at least one entity of a personal computer, which entity can be executed on the virtualization layer and has a service unit to provide data processing resources for a virtualization interface of a terminal, and
a protocol conversion unit coupled to the interface to interchange data.

12. The computer according to claim 11, wherein the protocol conversion unit is implemented within the at least one entity of the personal computer.

13. The computer according to claim 11, wherein the protocol conversion unit is in the form of additional hardware.

14. An assembly for virtual data processing comprising:
the computer for virtual data processing,
at least one terminal for operation with an assembly for virtual data processing comprising:
a controller,
an adaptation unit coupled to the controller,
a virtualization interface linked to the controller and which accesses data processing resources,
a display coupled to the virtualization interface via the adaptation unit which displays information,
a communication unit coupled to the controller and to the virtualization interface,
an energy supply coupled to the controller which provides energy to operate the terminal,
wherein the controller, the energy supply, the adaptation unit, the virtualization interface and the communication unit are integrated in a housing of the display, and
a communication network which interchanges data between the computer and the at least one terminal.

15. A method for virtual data processing with an assembly according to claim 14, comprising:
switching on the terminal,
setting up a connection from the terminal to the computer,
displaying state information on the terminal,
using the terminal for data processing, and
switching off the terminal.

16. The method according to claim 15, wherein the operation of switching on the terminal comprises identification of a user.
